(19) United States
(12) Patent Application Publication
(10) Pub. No.: US 2010/0161421 A1
(43) Pub. Date: Jun. 24, 2010

(54) System and Method for Providing Advertisement Lead Interaction

(76) Inventors: Edward W. Mandel, Frisco, TX (US); Enrique Sanchez, JR., Burleson, TX (US)

Correspondence Address: CARSTENS & CAHOON, LLP, P O BOX 802334, DALLAS, TX, 75380, US

(21) Appl. No.: 12/437,197

(22) Filed: May 7, 2009

Related U.S. Application Data
(63) Continuation-in-part of application No. 12/348,653, filed on Jan. 5, 2009.
Application No. 12/348,653 is a continuation-in-part of application No. 12/340,195, filed on Dec. 19, 2008.

(51) Int. Cl. G06Q 30/00; G06F 3/01

(52) U.S. Cl. 705/14.55; 705/14.4; 705/14.73; 715/701

(57) ABSTRACT

A system and method for providing live-interaction between a user and a call center representative regarding an advertisement of interest. The method is operable as program steps running on a stored program computer having networking capabilities. The system comprises a live-interaction routing module, an ad request module, an ad content rendering module, a live-interaction module, and an ad lead interface module. The user generates a live-interaction request which the system routes to an available call center representative. The communication request information causes an ad publishing service to provide advertising content to be delivered to the user's browser, and a communications link to be established between the user and representative. The system further allows the representative to provide additional ad related content to the user during the communication session.

### CROSS-REFERENCE TO RELATED APPLICATIONS

This application is a continuation-in-part of U.S. patent application Ser. No. 12/348,653, which was filed on Jan. 5, 2009.

### STATEMENT REGARDING SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates to web advertising services, and more specifically live-interaction content rendering systems.

2. Description of Related Art Including Information Disclosed Under 37 CFR 1.97 and 1.98

The more quickly you can get a potential customer in contact with an advertiser, the greater the likelihood that the potential customer becomes a customer. Prior solutions only provide a link to the website or perhaps a phone number or e-mail address in the ad. Worse yet, most prior solutions require the potential customer to go to the advertiser's website to search for contact information.

### BRIEF SUMMARY OF THE INVENTION

The present invention provides a method, system, and computer software for providing advertisement lead interaction associated with a displayed ad in a networked environment. A networked application accesses a computing device that performs the novel method steps.

The method is operable as program steps running on a stored program computer having networking capabilities. The system comprises a live-interaction routing module, an ad request module, an ad content rendering module, a live-interaction module, and an ad lead interface module.

The method steps comprise receiving a live-interaction request; determining a call center representative; routing the live-interaction request to the call center representative; extracting an ad identification number from the live-interaction request; requesting ad content from an ad publishing service, wherein the ad content is related to the ad identification number; receiving ad content from the ad publishing service; displaying the ad content in a first area of the ad lead interface; displaying the call center representative's view in a second area of the ad lead interface; displaying the user's view in a third area of the ad lead interface; and transferring call center representative-selected content to the user's view.

### BRIEF DESCRIPTION OF THE SEVERAL VIEWS OF THE DRAWING(S)

The present invention will be more fully understood by reference to the following detailed description of the preferred embodiments of the present invention when read in conjunction with the accompanying drawings, wherein:

FIG. 1 exemplifies a diagram of an advertisement lead interaction system in a networked environment, in accordance with principles of the present invention; and

FIG. 2 exemplifies a diagram of a method for providing advertisement lead interaction, in accordance with principles of the present invention.

The above figures are provided for the purpose of illustration and description only, and are not intended to define the limits of the disclosed invention. Use of the same reference number in multiple figures is intended to designate the same or similar parts. Furthermore, if and when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the particular embodiment. The extension of the figures with respect to number, position, relationship, and dimensions of the parts to form the preferred embodiment will be explained or will be within the skill of the art after the following teachings of the present invention have been read and understood.

### DETAILED DESCRIPTION OF THE INVENTION

In the following discussion, numerous specific details are set forth to provide a thorough understanding of the present invention. However, it will be obvious to those skilled in the art that the present invention may be practiced without such specific details. In other instances, well-known elements have been illustrated in schematic or block diagram form in order not to obscure the present invention in unnecessary detail. Additionally, for the most part, details concerning the Internet, digital content, and the like have been omitted inasmuch as such details are not considered necessary to obtain a complete understanding of the present invention, and are considered to be within the skills of persons of ordinary skill in the relevant art.

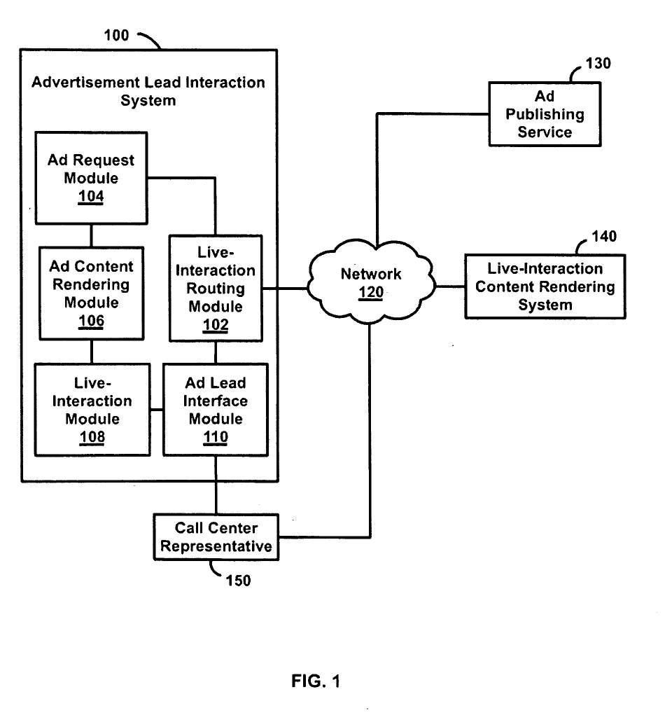

Referring to FIG. 1, there is shown a diagram of a live-interaction content interaction system (100) for providing live-interaction content associated with an advertisement over a computer network, in accordance with principles of the present invention. The system (100) is part of an application adapted to provide search results and advertisements associated with a search term. The application can be resident on a computer, a website, blog, forum, aggregator, and other suitable web-enabled computer-based application. The system (100) is preferably implemented in hardware, software, or a suitable combination of hardware and software thereof and may comprise one or more software systems operating on a digital signal processing platform or other suitable computer processing platforms.

As used herein, “hardware” includes, but is not limited to, a combination of discrete electronic components; an integrated circuit; a microprocessor; a controller; a microcontroller; an application-specific integrated circuit (ASIC); an electronic data processor; a computer; a field programmable gate array (FPGA); or other suitable hardware connectable for interfacing with a computer network, such as the Internet, considered to be well-known in the art. As used herein, “software” includes, but is not limited to, one or more objects; agents; threads; lines of code; subroutines; separate software applications; two or more lines of code or other suitable software structures operating in two or more software applications or on two or more processors; or other suitable hardware structures. Furthermore, it is considered that the design, development, and implementation details of all such hardware and software would be apparent to a person having ordinary skill in the art based upon a review of the present description of the invention. In one embodiment, software can include one or more lines of code or other suitable software structures operating within a general purpose software application, such as an operating system, or operating as a stand-alone specific purpose software application.

The system (100) in a first embodiment presents content associated with the advertisement to call center representative (150), and is operably coupled to advertisement publishing service (130) and live-interaction content rendering system (140) by network (120). The network can be a WAN, MAN, LAN, PAN, or other suitable network.

The system (100) is adapted to receive a communication request to provide live-interaction with a contact having information about an advertisement displayed in a user's web-browser or graphical user interface (GUI) and routes the request to a call center representative (150) associated with advertisement contact information. The system (100) in this embodiment also includes live-interaction routing module (102), ad request module (104), ad content rendering module (106), live-interaction module (108), and ad lead interface module (110).

The live-interaction routing module (102) is adapted to receive the user's request for live-interaction with the call center representative (150) regarding information about an advertisement of interest to the user. In this embodiment, the communication request is a data packet or data packets having the user's IP address, an ad identification number of the advertisement the user requested information on, and an indication of the desired mechanism for communication with the user. The communication mechanism can be any means by which information can be exchanged between the call center representative (150) and the user, such as but not limited to video-conferencing, VoIP, chat, text, or the like.

In another embodiment the communication request is parsed and stored in a database for subsequent processing. The request is then routed to the first available call center representative (150). A representative (150) that is not communicating with a user is flagged as “available” by the ad lead interface module (110). If there are no available representatives (150), the live-interaction routing module (102) polls the system until a representative (150) becomes available, and routes the communication request to that representative (150). The live-interaction routing module (102) can be achieved with an application programming interface (API), a network connection, a network transfer protocol, HTML, DHTML, Java, JavaScript. Dojo, Ruby, Rails, other suitable formats and applications, or a suitable combination thereof.

The ad request module (104) is adapted to receive the ad identification number from the request and generate an ad request that is sent to the ad publishing service (130). In one embodiment, the ad request includes the ad identification number and the representative's (150) IP address. The ad request module (104) can be achieved with an application programming interface (API), a network connection, a network transfer protocol, HTML, DHTML, Java, JavaScript, Dojo, Ruby, Rails, other suitable formats and applications, or a suitable combination thereof.

The ad content rendering module (106) is adapted to receive ad content associated with an ad identification number from the ad publishing service (130) and generate code to display a list to the representative (150). In the present embodiment the ad content includes the list of the ad content and its associated network location, such as the server name, IP address, and other suitable information. In another embodiment the list is displayed in a first area of the interface (110). In yet another embodiment each item in the list is hyperlinked to its associated network location. In yet another embodiment, each item is sorted into media type and displayed under a media type heading. The ad content rendering module (106) can be achieved with an application programming interface (API), a network connection, a network transfer protocol, HTML, DHTML, Java, JavaScript, Dojo, Ruby, Rails, other suitable formats and applications, or a suitable combination thereof.

The live-interaction module (108) is adapted to establish communication between the user and the call center representative (150) associated with the advertisement. The communication data is displayed in a representative's view area disposed in a second region of the interface (110). In one embodiment, a video-conference is established using a standard-based video-conferencing API. The video-conference is displayed in the representative's view area of interface (110). In yet another embodiment, the standard-based video-conferencing API is the Java Media Framework (JMF) API. In yet another embodiment, the JMF 2.11e API can be used to establish the audio, video, and other media conferencing. In yet another embodiment, a JMF Server applet can capture audio and video, store the data in a buffer, and transmit the data to a JMF client applet as a Real-time Protocol (RTP) stream. In yet another embodiment, an audio codec, such as G.711 and G.722, a video codec, such as H.263 and H.264, and a transfer protocol, such as RTP, are utilized to instantiate a video-conference between the user and the ad representative (150).

Although a video-conferencing is a preferred live-interaction method, the conference can also be established by sending either video-only or audio-only to the user and/or the ad representative. In another embodiment, the user receives streaming video and audio via the application and communicates with the ad representative (150) via one of the plurality of communication mechanisms or over the phone by calling the call center (140). In yet another embodiment, the live-interaction method can be a chat window disposed in the representative's view area of interface (110). The live-interaction module (108) can be achieved with an application programming interface (API), a network connection, a network transfer protocol, a video codec, an audio codec, HTML, DHTML, Java, JavaScript, Dojo, Ruby, Rails, other suitable formats and applications, or a suitable combination thereof.

The ad lead interface module (110) is adapted to display the listing of the ad content, representative's view, a user's view, and session controls. In one embodiment, the live-interaction communication that occurs with the user is displayed in a user's view area disposed within a third area of the interface. The representative's (150) mouse is then used to interact with the interface. In another embodiment session controls disposed in the interface allow the representative (150) to terminate the communication session, pause the transmission, or connect with the user. In another embodiment, the representative (150) logs into the system (100) by entering his representative id and the associated password. In another embodiment, the login notifies the system that the representative (150) is available. In another embodiment, the interface (110) displays a notification to the representative (150) indicating that a user is requesting live-interaction. The ad lead interface module (110) can be achieved with an application programming interface (API), a network connection, a network transfer protocol, a video codec, an audio codec, HTML, DHTML, Java, JavaScript, Dojo, Ruby, Rails, other suitable formats and applications, or a suitable combination thereof.

During operation, the call center representative (150) logs into system (100). Once logged in, the representative (150) receives a notification to connect with a user that desires more information about a particular ad. The representative then clicks on a connect button on his or her GUI to instantiate the live-interaction session. In one embodiment, a video-conference is instantiated with the user and a listing of the content associated with the ad is displayed in the first area of the interface visible to both the user and the representative. The representative greets the user and begins discussion about the ad. In another embodiment a script to be read by the representative (150) is loaded in a fourth area of the interface (110) visible only to the representative. The representative can then select an item in the list to view additional related detail. In another embodiment the representative (150) can select an item and drag it onto the user's area to display the item to the user in the user's video-conference window. In another embodiment the representative (150) can select an item and drag it onto the user's area to display the item to the user in a new window. The representative (150) can show video, images, PDF files, audio files, and other suitable media type files to the user. Once the live-interaction has concluded, the representative can select an “end session” button to terminate the session and provide notification to the system (100) that the representative (150) is available to handle another communication request.

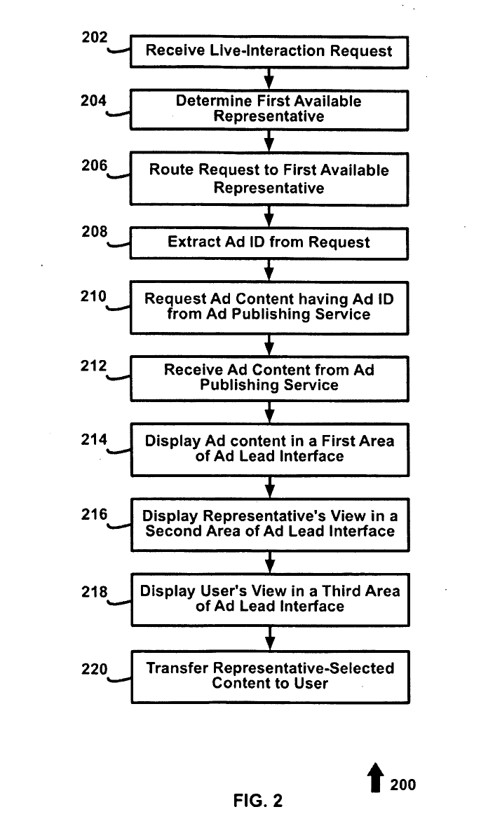

Referring now to FIG. 2, there is shown a flow chart (200) exemplifying control logic embodying features of a method for providing advertisement lead interaction in accordance with the principles of the present invention. The advertisement lead interaction control logic (200) can be implemented as an algorithm on a general purpose computing platform or other suitable microprocessor-based system having computer networking capabilities.

The advertisement lead calling control logic (200) can leverage the ability of a computer platform to spawn multiple processes and threads by processing data simultaneously. The speed and efficiency of the advertisement lead interaction control logic (200) is greatly improved by instantiating more than one process to implement live-interaction between the user and the ad representative (150). However, one skilled in the art of programming will appreciate that use of a single processing thread may also be utilized and is within the scope of the present invention.

The advertisement lead interaction control logic process flow (200) of the present embodiment begins at step 202, where a live-interaction request is received by the call center representative (150) from a user who wishes to obtain additional information regarding an advertisement. In one embodiment, the communication request is a data packet or data packets having the user's IP address, the advertisement identification of the advertisement of interest, and the requested communication mechanism. The communication mechanism can be any means by which live-interaction information can be exchanged between the call center representative (150) and the user, such as but not limited to video-conferencing VoIP, chat, text, or the like.

At step 204, the method (200) determines the first available call center representative (150). In one embodiment, a call center representative (150) is available if they are not communicating with a user. In another embodiment, a representative (150) that is not communicating with a user is flagged as available by ad lead interface module (110). If there are no available representatives (150), the live-interaction routing module (102) polls the system until a representative (150) becomes available. The logic then proceeds to step 206.

At step 206, the request is routed to the first available call center representative (150). In one embodiment, the request is routed via a network to the first representative (150) that was flagged as available. The logic then proceeds to step 208.

At step 208, the advertisement identification number is parsed from the request. In one embodiment, the request has fields. In another embodiment, at least one of the fields is the ad identification number. The logic then proceeds to step 210.

At step 210, an ad request is generated and sent to the ad publishing service (130). In one embodiment, the ad request includes the ad identification number and the representative's (100) IP address. The logic then proceeds to step 212.

At step 212, ad content associated with the ad identification number is received from ad publishing service (130). The logic then proceeds to step 214.

At step 214, code is generated to display a listing of the ad content to the representative (150). In one embodiment, the list of the ad content is displayed in a first area of the interface (110). In another embodiment, each item in the list is a hyperlink to the associated network location. In another embodiment, each item is sorted into media type and displayed under a media type heading. The logic then proceeds to step 216.

At step 216, the live-interaction is displayed in a representative's view area disposed in a second region of the interface (110). In one embodiment, a video-conference is established using a standard-based video-conferencing API. The video-conference is displayed in the representative's view area of the interface (110). The logic then proceeds to step 218.

At step 218, the live-interaction communication sent to the user is displayed in the user's view area disposed in third area of the interface (110). The logic then proceeds to step 220.

At step 220, representative-selected content is transferred to the user. In one embodiment, a script to be read by the representative (150) is loaded in a fourth area of the interface (110). In another embodiment, the representative can select an item in the list in order to view the associated ad content. In another embodiment, the representative (150) can select an item and drag it onto the user's area to display the item to the user in the user's video-conference window. In another embodiment, the representative (150) can select an item and drag it onto the user's area to display the item to the user in a new window. The representative (150) can show to the user media formats such as, but not limited to, video, images, PDF files, audio files, and the like.

The invention may be embodied in other specific forms without departing from the spirit or essential characteristics thereof. The present embodiments are therefore to be considered in all respects as illustrative and not restrictive. Accordingly, the scope of the invention is established by the appended claims rather than by the foregoing description. All changes, which come within the meaning and range of equivalency of the claims are therefore intended to be embraced therein. Further, the recitation of method steps does not denote a particular sequence for execution of the steps. Such method steps may therefore be performed in a sequence other than that recited unless the particular claim expressly states otherwise.

We claim:

1. A method for providing, in a networked environment, live advertisement lead interaction to allow a user to obtain additional information concerning advertised goods or services from a call center representative, wherein the user's computer browser interface displays at least one advertisement, and wherein the call center representative interacts with the user through a call center representative computer browser interface, the method steps comprising:
providing a live-interaction routing module;
providing an ad request module;
providing an ad content rendering module;
providing a live-interaction module; and
providing an ad lead interface module.

2. The method of claim 1, wherein the live-interaction routing module is adapted to receive a communication request regarding information related to an advertisement of interest.

3. The method of claim 2, wherein the ad request module generates an ad request based upon the communication request.

4. The method of claim 1, wherein the ad content rendering module is adapted to receive advertising content associated with an ad identification number, and wherein the ad content rendering module generates a list for display on the call center representative's interface.

5. The method of claim 4, wherein the list comprises the ad content and the associated network location of the ad content.

6. The method of claim 1, wherein the live-interaction module is adapted to establish communication between the user and the call center representative by exchanging communication data with the user's browser and the call center representative's browser.

7. The method of claim 6, wherein the communication data comprises communication technology chosen from the group consisting of video-conferencing data, an RTP data stream, and VOIP.

8. The method of claim 1, wherein the ad lead interface module is adapted to generate a display of the listing of the advertising content, the call center representative's view, and the user's view.

9. The method of claim 1, wherein the ad lead interface module allows the representative to interact with the user's interface by manipulation of the representative's computer mouse.

10. The method of claim 9, wherein the ad lead interface module allows the representative to control and display audio or video data in the user's interface.

11. A computer software program tangibly embodied in a computer readable medium, the program including machine-readable instructions executable by a computer processor to perform a method for providing, in a networked environment, live advertisement lead interaction to allow a user to obtain additional information concerning advertised goods or services from a call center representative, wherein the user's computer browser interface displays at least one advertisement, and wherein the call center representative interacts with the user through a call center representative computer browser interface, the program steps comprising:
receiving a live-interaction request from a user;
routing the live-interaction request to a call center representative;
extracting an ad identification number from the live-interaction request;
requesting ad content from an ad publishing service, wherein the ad content is related to the ad identification number;
generating an ad lead interface, wherein the ad content is displayed in a first area of the ad lead interface;
displaying the call center representative's view in a second area of the ad lead interface;
displaying a user's view in a third area of the ad lead interface; and
allowing live-interaction exchange of information between the call center representative's interface and the user's interface.

12. The computer software program of claim 11, the program steps further comprising:
allowing transfer of call center representative selected content to the user's view.

13. The computer software program of claim 11, the program steps further comprising:
allowing the call center representative to interact with the user's interface through manipulation of the representative's computer mouse in the representative's interface.

14. The computer software program of claim 11, the program steps further comprising:
selecting an available call center representative from a plurality of call center representatives for handling the live-interaction request.

15. A system for providing, in a networked environment, live advertisement lead interaction to allow a user to obtain additional information concerning advertised goods or services from a call center representative, wherein the user's computer browser displays at least one advertisement, and wherein the call center representative interacts with the user through a call center representative computer browser, the system comprising:
at least one computer device, wherein the at least one computer device is attached to a network;
a live-interaction routing module operable on the at least one computer device;
an ad request module operable on the at least one computer device;
an ad content rendering module operable on the at least one computer device;
a live-interaction module operable on the at least one computer device; and
an ad lead interface module operable on the at least one computer device.

16. The system of claim 15, wherein the live-interaction routing module is adapted to receive a communication request regarding information related to an advertisement of interest.

17. The system of claim 16, wherein the ad request module generates an ad request based upon the communication request.

18. The system of claim 15, wherein the ad content rendering module is adapted to receive advertising content associated with an ad identification number, and wherein the ad content rendering module generates a list for display on the call center representative's interface.

19. The system of claim 18, wherein the list comprises the ad content and the associated network location of the ad content.

20. The system of claim 15, wherein the live-interaction module is adapted to establish communication between the user and the call center representative by exchanging communication data with the user's browser and the call center representative's browser.

21. The system of claim 20, wherein the communication data comprises communication technology chosen from the group consisting of video-conferencing data, an RTP data stream, and VOIP.

22. The system of claim 15, wherein the ad lead interface module is adapted to generate a display of the listing of the advertising content, the call center representative's view, and the user's view.

23. The system of claim 15, wherein the ad lead interface module allows the representative to interact with the user's interface by manipulation of the representative's computer mouse.

24. The system of claim 23, wherein the ad lead interface module allows the representative to control and display audio or video data in the user's interface.

25. The system or claim 15, the system further comprising:
a plurality of networked computer devices, wherein at least one of the listed modules is operable on a computer device that is separate from the computer devices upon which the other modules operate.
